(19) United States
(12) Patent Application Publication
(10) Pub. No.: US 2025/0173420 A1
(43) Pub. Date: May 29, 2025

(54) AUTHENTICATION METHOD

(71) Applicant: STMicroelectronics International N.V., Geneva (CH)

(72) Inventors: Michael PEETERS, Tourinnes-la-Grosse (BE); Francois DE ROCHEBOUET, Toulon (FR); Jean-Louis MODAVE, Ottignies (BE)

(73) Assignee: STMicroelectronics International N.V., Geneva (CH)

(21) Appl. No.: 18/953,647

(22) Filed: Nov. 20, 2024

(30) Foreign Application Priority Data
Nov. 23, 2023 (EP) 23307038.2
Mar. 11, 2024 (FR) 2402393

(51) Int. Cl. G06F 21/44

(52) U.S. Cl. CPC G06F 21/44

(57) ABSTRACT

A method of authentication of a first device to a second device uses a signature of an analog signal of the first device. The signature corresponds to a time variation of at least one physical quantity associated with the analog signal during the implementation of at least one specific operation. The at least one specific operation may be an implementation of an electronic function or a program.

### PRIORITY CLAIM

This application claims the priority benefit of European Application for Patent No. 23307038.2, filed on Nov. 23, 2023, and claims the priority benefit of French Application for Patent No. 2402393, filed on Mar. 11, 2024, the contents of which are hereby incorporated by reference in their entireties to the maximum extent allowable by law.

### TECHNICAL FIELD

The present disclosure generally concerns electronic circuits and devices and, more particularly, the security of electronic circuits and devices. The present disclosure more specifically concerns the implementation of an authentication method enabling, for example, a plurality of electronic devices to start a reliable communication.

### BACKGROUND

A communication between two electronic devices, or circuits, is often preceded by an authentication phase. During this phase, an authentication method, implemented by both devices, enables to verify whether the two devices are authorized to communicate with each other.

Authentication methods are often used during a communication between a device of terminal type and an electronic equipment or device of peripheral type, for example a consumable or an accessory. The authentication method enables, in this case, to validate the access of the peripheral device to the data and/or to functionalities of the device of terminal type. The authentication method is a first line of protection against malicious devices trying to access data and/or functionalities of other devices.

It would be desirable to be able to improve, at least partly, known authentication methods.

There exists a need for more secure authentication methods, allowing a more reliable authentication of an electronic circuit or device to another electronic circuit or device.

In particular, there exists a need to avoid for a clone of an electronic device to be able to authenticating itself in its place.

There exists a need for electronic circuits and devices implementing more secure authentication methods.

There is a need in the art to overcomes all or part of the disadvantages of known authentication methods.

### SUMMARY

An embodiment provides an authentication method using a signature of an analog signal of an electronic device as a means of identification.

An embodiment provides a method of authentication of a first device to a second device, wherein a signature of a first analog signal of said first device is used for the authentication.

Another embodiment provides a system of authentication of a first device to a second device, wherein a signature of a first analog signal of said first device is used for the authentication.

According to an embodiment, said signature corresponds to the time variation of at least one physical quantity associated with said first signal during the implementation of at least one specific operation.

According to an embodiment, said operation is the implementation of an electronic function or of a program.

According to an embodiment, said signature is obtained by at least one circuit for measuring said analog signal.

According to an embodiment, said at least one measurement circuit forms part of said first device, of said second device, or of a third electronic device external to said first and second devices.

According to an embodiment, during the implementation of said operation, the first device is in a secure mode.

According to an embodiment, said second device verifies said signature by using at least one signature model.

According to an embodiment, said second device verifies said signature by comparing it with said at least one signature model.

According to an embodiment, said second device verifies said signature by extracting data from said signature.

According to an embodiment, said second device verifies said signature by using a neural network.

According to an embodiment, said neural network has been trained based on data representing signature models.

According to an embodiment, when said signature is transmitted between the first and second devices, said signature is encrypted.

According to an embodiment, the authentication method is of verifier/prover type.

According to an embodiment, the authentication system is of verifier/prover type.

According to an embodiment, a signature of at least one second analog signal of said first device is used for the authentication.

According to an embodiment, said first signal in an excess current rejected by the current smoothing circuit of a circuit for powering said first device.

According to an embodiment, said circuit for powering said first device comprises an analog-to-digital converter configured to measure said excess current, said analog-to-digital converter being configured to store data into a memory.

Another embodiment provides an electronic device as the first device in the previously-described method, or in the previously-described system.

Another embodiment provides an electronic device as the second device in the previously-described method, or in the previously-described system.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an example of an electronic device configured to implement the implementation modes of an authentication method described in relation with FIGS. 2 and 3;

FIG. 2 shows a block diagram illustrating a first implementation mode of a method of authentication of a first device to a second device;

FIG. 3 shows a block diagram illustrating a second implementation mode of a method of authentication of a first device to a second device;

FIG. 4 shows, very schematically and in the form of blocks, an example of embodiment of an electronic device power supply circuit;

FIG. 5 shows, very schematically and in the form of blocks, another example of embodiment of an electronic device power supply circuit; and

FIG. 6 shows a block diagram illustrating a third implementation mode of a method of authentication of a first device to a second device.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

The embodiments described hereafter concern the implementation of an authentication method enabling to authenticate a first electronic device to a second electronic device, for example, for a future communication between these first and second devices. These embodiments are, more particularly, authentication methods of verifier/prover type, also known as verifier/candidate type, in which a verifier device, here the second device, sends data to the prover (candidate) device, here the first device, so that it applies a transformation thereto. The prover (candidate) device then sends the result of said transformation back to the verifier device so that it verifies it. If the result of the verification is correct, then the prover (candidate) device is authenticated to the verifier device.

In this context an authentication system is referred to as an electronic system comprising a verifier device and a prover device.

One of the aims of these embodiments is to provide more secure and more reliable authentication methods, and in particular authentication methods configured to differentiate an electronic device from one of its clones. What is referred to as a “clone” means an electronic device manufactured to have the same operation/behavior as another device, with the aim of taking its place, for example for malicious purposes.

The solution provided by the embodiments described hereafter is to use a signature of an analog signal of the first device to authenticate it to the second device. Reference to a “signature of an analog signal” means the recording of the time variation of one or a plurality of physical quantities associated with said analog signal during the implementation, by the first device, of at least one specific operation, such as the implementation of an electronic function or of a program. This quantity may be its amplitude in voltage, in current, its frequency, etc., examples of which are detailed hereafter. According to the described embodiments, this signature is obtained by use of one or a plurality of measurement circuits forming part of the first device, of the second device, or of a third device external to the first and second devices. This signature is supplied to the second device, which verifies it by using, for example, one or a plurality of signature models. According to a specific embodiment, the second device may use a neural network to verify, classify, or even compare all or part of the signature supplied with the signature model(s).

The use of such an analog signature enables to differentiate an electronic device from one of its clones. Indeed, the time variation of an analog signal depends not only on the operation implemented by the device, but also depends on the material reality of the device, such as on the layout of the electronic components that make it up, on manufacturing processes used, etc. Thus, a plurality of electronic devices originating from a same manufacturer will have very similar or even identical signatures, but a clone will almost certainly have a different signature.

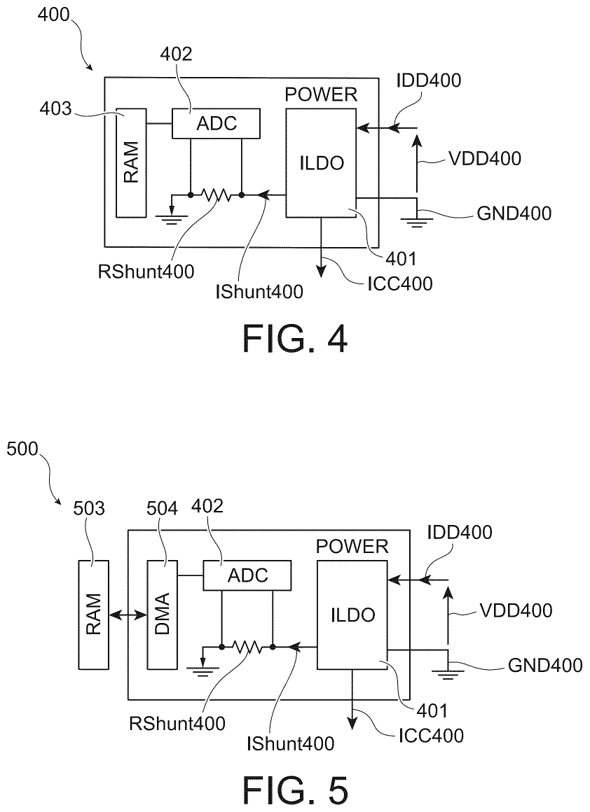

A specific solution provided by the embodiments described hereafter is to generate a signature by using a current rejected by a current smoothing circuit of the prover device. Such a current smoothing circuit is used to smooth a power supply current of an electronic device. This type of circuit is used to prevent side-channel attacks, which enable to recover data from, among others, a power supply current. A current smoothing circuit generally rejects an excess current corresponding to the difference between a fixed current and the power supply current. These embodiments are described in relation with FIGS. 4 to 6.

Further, the embodiments described hereafter are particularly configured for being used in any type of system requiring the authentication of two electronic circuits or devices, such as, for example, a system comprising a device of terminal type and a device of peripheral or consumable type, or such as, for example, a system formed on a same chip comprising a plurality of electronic circuits.

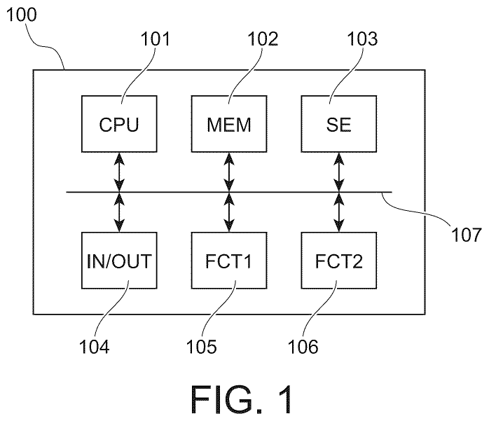

FIG. 1 is a block diagram very schematically showing an architecture of an example of an electronic device 100 configured to implement an authentication method according to an embodiment. Device 100 may indifferently be a verifier device or a prover device of said authentication method.

According to an example, electronic device 100 comprises a processor 101 (CPU) configured to implement different data processing operations with respect to data stored in memories and/or provided by other circuits of device 100. According to an embodiment, processor 101 is configured to implement an authentication method.

According to an example, electronic device 100 further comprises different types of memories 102 (MEM), such as, for example, a non-volatile memory, a volatile memory, and/or a read-only memory. Each memory 102 is configured to store different types of data.

According to an example, electronic device 100 further comprises a secure element 103 (SE) configured to process sensitive and/or secret data. Secure element 103 may comprise its own processor(s), its own memory or memories, etc. According to an embodiment, secure element 101 is configured to implement an authentication method.

According to an example, electronic device 100 may further comprise interface circuits 104 (IN/OUT) configured to send and/or to receive data originating from the outside of device 100. Interface circuits 104 may further be configured to implement a data display, for example, a display screen.

According to an example, electronic device 100 further comprises different circuits 105 (FCT1) and 106 (FCT2) configured to perform different functions. As an example, circuits 105 and 106 may comprise measurement circuits, data conversion circuits, etc. According to an embodiment, circuits 105 and 106 may comprise one or a plurality of circuits configured to implement an authentication method. According to a specific embodiment, circuits 105 may comprise measurement circuits, analog-to-digital converters, calculation circuits, etc.

According to an example, electronic device 100 further comprises one or a plurality of data buses 107 configured to transfer data between its different components.

According to an embodiment, a system comprising two devices of the type of device 100 may be configured to implement an authentication method according to an embodiment. Such a system is referred to herein as an authentication system.

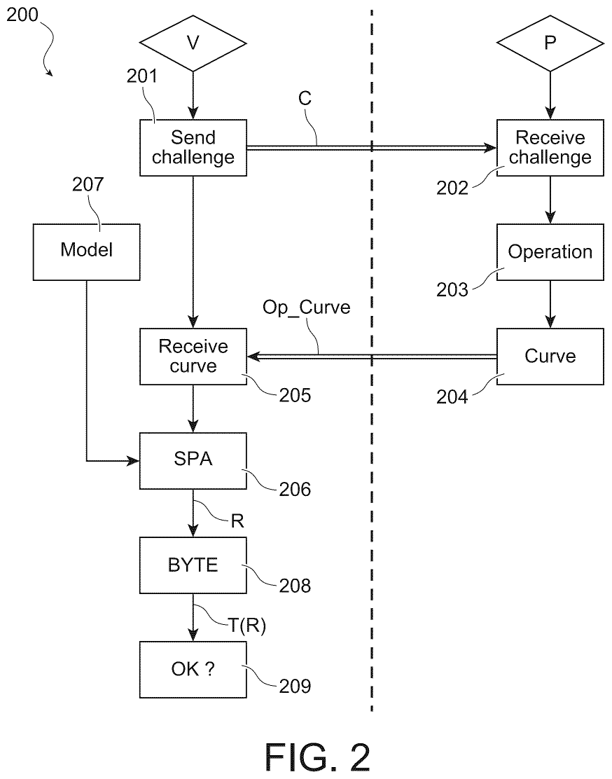

FIG. 2 is a block diagram illustrating a first implementation mode of an authentication method 200 enabling to authenticate a first electronic device P, referred to as a prover device P, to a second electronic device V, referred to as a verifier device V. In other words, authentication method 200 is configured to being implemented by an authentication system comprising devices P and V. According to an embodiment, devices P and V are of the type of the device 100 described in relation with FIG. 1.

As described hereabove, authentication method 200 is a method of verifier/prover type.

At an initial step 201 (Send Challenge), authentication method 200 begins, for this purpose verifier device V selects a data item C, referred to as a challenge data item C, to send to prover device P. According to an example, challenge C is a set of binary data.

According to an embodiment, data item C is selected from a finite group of data enabling to implement authentication method 200, according to an embodiment the size of the group is determined by the format of the data that it comprises, for example 128-bit binary data. According to an example, the group may comprise initialization data for the specific operation implemented by prover device P, for example generated randomly or pseudo-randomly by using a leakage model. According to an example, when the specific operation is the use of an AES-type encryption algorithm, the data may be pairs of data comprising an input value and an encryption key. According to another example, the group may comprise encrypted data.

At a step 202 (Receive Challenge), successive to step 201, prover device P receives data item C and can begin to implement the authentication method.

At a step 203 (Operation), successive to step 202, prover device P uses data item C to implement a specific operation. According to an embodiment, this operation is the implementation of an electronic function, such as a specific circuit of device P, or of a program. According to an embodiment, this operation is an operation comprising an operating scheme specific to prover device P, that is, dependent on the structure of prover device P or on its manufacturing process. According to an embodiment, this operation is an operation which lets data leak. Further, the use of data item C must have an influence on the operation and/or the result of the operation.

According to an example, the specific operation comprises the application of a data encryption algorithm, for example by using data item C as an encryption key, or for example by applying this algorithm to data item C. According to a specific example, the specific operation consists in the application of an algorithm of AES (Advanced Encryption Standard) type.

According to a specific embodiment, during the implementation of the specific operation, prover device P is in a secure mode, enabling it to be less sensitive to external attacks.

At a step 204 (Curve), successive to step 203, one or a plurality of measurement circuits of prover device P are implemented to obtain a signature Op_Curve of at least one analog signal of prover device P during the implementation of the specific operation of step 203. What is referred to here as a signature of an analog signal means the time variation of one or a plurality of physical quantities associated with said analog signal over a given period of time. In the present case, the signature Op_Curve of the analog signal is recorded during the implementation of the specific operation. To obtain such a signature, one or a plurality of analog signals may be used, separately or being combined. According to an embodiment, the measurement circuit(s) of device P can measure the signature of one or a plurality of analog signals.

According to a first example, the analog signal(s) measured by the measurement circuits of P device may originate from analog circuits of device P, such as amplifiers, oscillators, timing circuits, and/or delay circuits. In this case, the measurement circuits can measure the time variation of the voltage, of the current, of the frequency and/or of the phase shift of these analog signals. What follows is a non-exhaustive list of analog signals capable of being used in this case: an internal power supply voltage of prover device P; an internal clock signal of prover device P; an analog signal originating from an interface circuit of prover device P; and/or an analog signal originating from a random access memory or from a non-volatile memory of prover device P.

According to a second example, the analog signal(s) measured by the measurement circuits of device P may originate from the power supply of the different circuits making up prover device P. Thus, the power supplies concerned may be the power supplies of a processor (CPU), of one or a plurality of memories, or even the general power supply of device P. In this case, the measurement circuits may enable to measure the time variation of the voltage or of the current of these power supplies.

According to a third example, the analog signal(s) measured by the measurement circuits of device P may originate from the activity of transistors comprised in the circuits making up device P. Thus, the concerned transistors may be transistors of the processor, transistors of circuits implementing functionalities in particular, such as the circuits 105 described in relation with FIG. 1, or even transistors forming part of the chip forming device P. In this case, the measurement circuits may enable to measure the time variation of the photon emission from these transistors, by using, for example, avalanche-effect diodes triggered by an individual photon and associated calculation methods. The measurement circuits may further enable to measure the time variation of electromagnetic emissions from these transistors, by using, for example, micro-coils on metal layers.

Once the signature Op_Curve of the analog signal(s) has been obtained, prover device P sends it to the verifier device. According to an embodiment, prover device P may send said signature Op_Curve in secure manner, for example by encrypting it.

At a step 205 (Receive Curve), successive to step 204, verifier device V receives the signature from prover device P.

At a step 206 (SPA), successive to step 205 and at a step 207 (Model), verifier device V verifies the received signature Op_Curve by verifying it by using one or a plurality of known signature models, for example by comparing it with one of these models, or by extracting data from this signature. This verification may be implemented, for example, by using a simple power or current analysis (SPA), or, for example, a “template attack” for which data extracted from a curve enable to find the curve model used. To implement such an attack, curve models are generated by performing tests on thousands of reference circuits, and by detecting points of interest on these curves, or to rank in decreasing order of probability the possible extracted, or leaked, values.

According to a preferred example, the verification of step 206 may be implemented by using artificial intelligence (AI), such as a neural network (NN) of a neural processing unit (NPU) trained based on the model(s). The use of a neural network has the advantage of being more difficult to grasp for someone who wishes to understand step 206. Indeed, the analysis of the structure of a circuit implementing a neural network does not enable to understand the operation(s) that it executes.

Further, at step 206, according to a variant, verifier device V can take into account data item C.

At the end of step 206, verifier device V obtains a result data item R.

At step 207, preceding step 206, the signature model(s) have been obtained, for example by obtaining signatures with a plurality of devices originating from a same manufacturing batch in a factory of a plurality of prover devices of the type of device P.

At a step 208 (BYTE), optional and successive to step 206, result data item R is modified, for example by being truncated, into a data item T(R).

At a step 209 (OK ?), successive to step 208, verifier device V uses data item T(R) to conclude as to the authentication or not of prover device P. In the case where step 208 is not implemented, result data R item is used at step 209.

As mentioned previously, an advantage of using a signature of one or a plurality of analog signals of an electronic device to authenticate it is that this may enable to differentiate a clone from a real device.

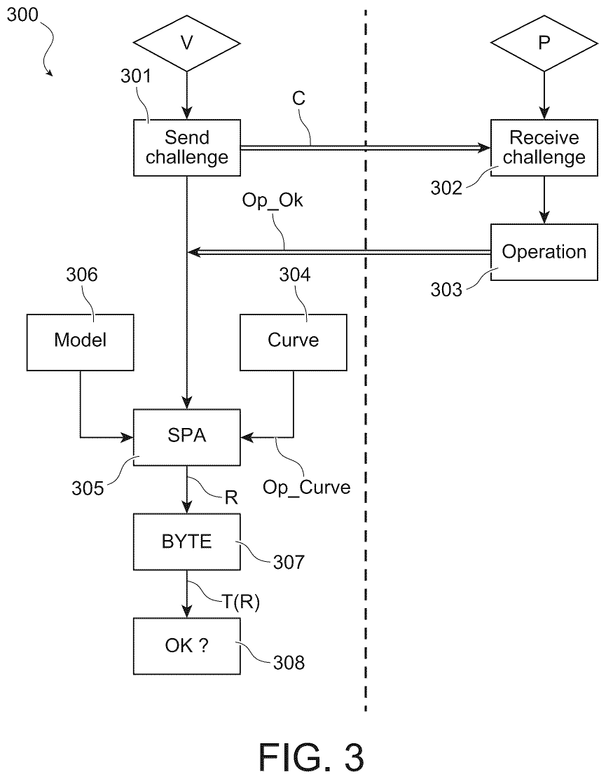

FIG. 3 is a block diagram illustrating a second implementation mode of an authentication method 300 enabling to authenticate a first electronic device P, referred to as a prover device P, to a second electronic device V, referred to as a verifier device V. In other words, authentication method 300 is configured to being implemented by an authentication system comprising devices P and V. According to an embodiment, devices P and V are of the type of the device 100 described in relation with FIG. 1.

Authentication method 300 has elements similar to the authentication method 200 described in relation with FIG. 2. The elements common to methods 200 and 300 are not described in detail again hereafter, and only the differences between devices 200 and 300 are highlighted.

More particularly, in authentication method 300, the measurement circuits enabling to obtain the signature of one or a plurality of analog signals of the prover device are not arranged on board prover device P, but on board verifier device V.

Authentication method 300 thus comprises the following successive steps: an initial step 301 (Send Challenge) identical to the step 201 of method 200; a step 302 (Receive Challenge) identical to the step 202 of method 200; a step 303 (Operation) similar to the step 203 of method 200; a step 304 (Curve) similar to the step 204 of method 200, but implemented by verifier device V; a step 305 (SPA) identical to the step 206 of method 200; a step 306 (Model) identical to the step 207 of method 200; a step 307 (BYTE) identical to the step 208 of method 200; and a step 308 (OK ?) identical to the step 209 of method 200.

In the case of method 300, step 303 further comprises the sending of a data item to the verifier device indicating that the operation has been successfully implemented, or, enabling verifier device V to verify that this operation has been successfully performed. According to an example, the specific operation of step 203 may be an operation of encryption of data item C with an encryption key, and the sent response may comprise the encrypted data item.

FIG. 4 shows, very schematically and in the form of blocks, an example of embodiment of a circuit 400 for powering an electronic device of the type of the electronic device 100 described in relation with FIG. 1.

According to an example, power supply circuit 400 is configured to receive a power supply voltage VDD400, a constant power supply current IDD400, and a reference potential GND400, for example the ground. According to an embodiment, the power supply circuit is configured to deliver a power supply current ICC400.

According to an embodiment, power supply circuit 400 comprises a current smoothing circuit 401 (ILDO) configured to receive a constant current IDD400 and to delivering, at its output, power supply current ICC400. Circuit 401 further rejects an excess current IShunt400 corresponding to the difference between power supply currents IDD400 and ICC400. This excess current IShunt400 may be used to analyze the activity of the electronic device comprising power supply circuit 400. Indeed, since the actual power supply current used by the device is not accessible, only the difference between constant power supply current IDD400 and current ICC400, that is, current IShunt400, shows the fluctuations of the electronic device power supply.

According to an example, power supply circuit 400 comprises a resistor RShunt400 enabling to dissipate excess current IShunt400. Resistor RShunt400 is coupled between circuit 401 and a terminal receiving reference potential GND400.

According to an example, power supply circuit 400 comprises an analog-to-digital converter 402 (ADC) arranged to enable to measure excess current IShunt400. Thus, converter 402 is coupled across resistor RShunt400.

According to an embodiment, power supply circuit 400 comprises a memory 403 (RAM) into which converter 402 is configured to store data, these data corresponding to the measurements of current IShunt400.

FIG. 5 shows, very schematically and in the form of blocks, another example of a circuit 500 for powering an electronic device of the type of the electronic device 100 described in relation with FIG. 1.

Power supply circuit 500 has elements similar to the power supply circuit 400 described in relation with FIG. 4. The elements common to circuits 400 and 500 are not described in detail again hereafter. Only the differences between devices 400 and 500 are highlighted.

The difference between circuits 400 and 500 is that, in circuit 500, the analog-to-digital converter is configured to store data into a memory which is external to circuit 500.

Thus, like circuit 400, circuit 500 comprises: current smoothing circuit 401 (ILDO); resistor RShunt400; and analog-to-digital converter 402 (ADC).

According to an embodiment, power supply circuit 500 comprises a direct memory access (DMA) circuit 504 enabling to access a memory 503 (RAM) external to power supply circuit 500. Converter 402 is configured to store data into memory 503 by using circuit 504.

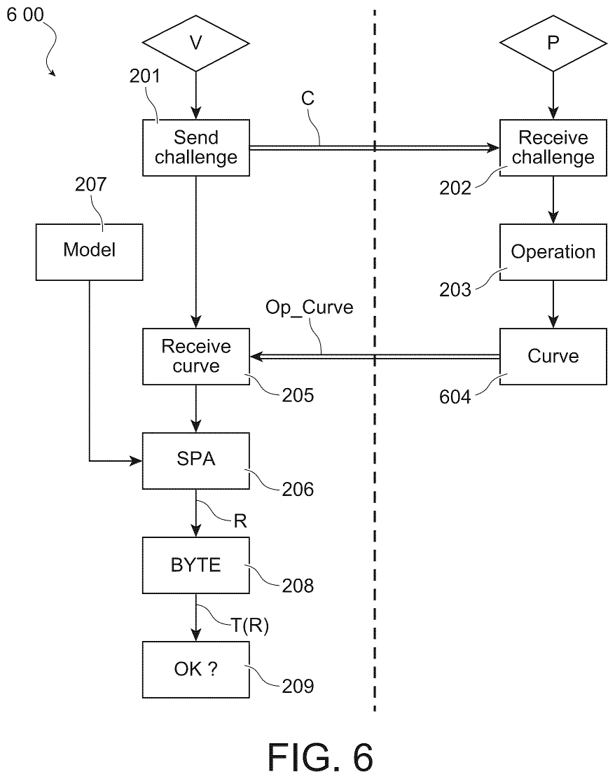

FIG. 6 is a block diagram illustrating a third implementation mode of an authentication method 600 enabling to authenticate a first electronic device P, referred to as a prover device P, to a second electronic device V, referred to as a verifier device V. In other words, authentication method 600 is configured to being implemented by an authentication system comprising devices P and V.

According to an embodiment, devices P and V are of the type of the device 100 described in relation with FIG. 1. Further, according to an embodiment, device P comprises a power supply circuit of the type of the circuit 400 described in relation with FIG. 4 or of the type of the circuit 500 described in relation with FIG. 5.

Authentication method 600 has elements similar to the authentication method 200 described in relation with FIG. 2. The elements common to methods 200 and 600 are not described in detail again hereafter, and only the differences between devices 200 and 600 are highlighted.

More particularly, in authentication method 600, the signature of one or a plurality of analog signals of the prover device is a measurement of the excess current IShunt400 of the circuit for powering device P.

Thus, authentication method 600 comprises the following successive steps: step 201 (Send Challenge); step 202 (Receive Challenge); step 203 (Operation); a step 604 (Curve) similar to the step 204 of method 200; step 205 (Receive Curve); step 206 (SPA); step 207 (Model); step 208 (BYTE); and step 209 (OK ?).

At step 604, successive to step 203, the analog-to-digital converter 402 of the power supply circuit of prover device P is implemented to obtain a signature Op_Curve of the excess current IShunt400 of circuit 401 during the implementation of the specific operation of step 203.

An advantage of this embodiment is that it enables to avoid the use of a current smoothing circuit.

Various embodiments and variants have been described. Those skilled in the art will understand that certain features of these various embodiments and variants may be combined, and other variants will occur to those skilled in the art. In particular, the measurement circuits used to obtain signature Op_Curve may form part neither of prover device P nor of verifier device V, but of an external device. This is the case, for example, when devices V and P are circuits arranged on a same chip, the measurement circuits may be arranged on the same chip without forming part of either device V or device P.

In addition, the authentication method could comprise an operation of authentication of verifier device V to prover device P before proceeding to the sending of challenge data item C.

Finally, the practical implementation of the described embodiments and variants is within the abilities of those skilled in the art based on the functional indications given hereabove.

1. A method of authenticating a first device to a second device, comprising:
generating a signature comprising a first analog signal of said first device; and
using the first analog signal to perform an authentication of the first device to the second device.

2. The method according to claim 1, wherein said signature corresponds to a time variation of at least one physical quantity associated with said first analog signal during the implementation of at least one specific operation.

3. The method according to claim 2, further comprising placing the first device in a secure mode during the implementation of said at least one specific operation.

4. The method according to claim 2, wherein said at least one specific operation is an implementation of an electronic function or a program.

5. The method according to claim 1, further comprising using at least one circuit for measuring said first analog signal to obtain said signature.

6. The method according to claim 5, wherein said at least one circuit for measuring is a circuit part of said first device.

7. The method according to claim 5, wherein said at least one circuit for measuring is a circuit part of said second device.

8. The method according to claim 5, wherein said at least one circuit for measuring is a circuit part of a third electronic device external to said first and second devices.

9. The method according to claim 1, further comprising verifying said signature by said second device using at least one signature model.

10. The method according to claim 1, further comprising verifying said signature by said second device by comparing the signature with at least one signature model.

11. The method according to claim 1, further comprising verifying said signature by said second device by extracting data from said signature.

12. The method according to claim 11, wherein verifying comprises using a neural network.

13. The method according to claim 12, wherein said neural network has been trained based on data representing signature models.

14. The method according to claim 1, further comprising encrypting said signature for transmission between the first and second devices.

15. The method according to claim 1, wherein the authentication is of verifier/prover type.

16. The method according to claim 1, further comprising using a signature of at least one second analog signal of said first device for the authentication.

17. The method according to claim 1, wherein said first analog signal comprises an excess current rejected by a current smoothing circuit of a circuit for powering said first device.

18. The method according to claim 17, wherein said circuit for powering said first device comprises an analog-to-digital converter configured to measure said excess current, said analog-to-digital converter being configured to store data into a memory.

19. An electronic device configured as the first device in the method according to claim 1.

20. An electronic device configured as the second device in the method according to claim 1.

21. A system, comprising:
a first device;
a second device; and
an authentication system wherein a signature of a first analog signal of said first device is used for authenticating the first device to said second device.

22. The system according to claim 21, wherein said signature corresponds to a time variation of at least one physical quantity associated with said first analog signal during the implementation of at least one specific operation.

23. The system according to claim 22, wherein said at least one specific operation is an implementation of an electronic function or of a program.

24. The system according to claim 21, further comprising at least one circuit configured to obtain said signature by measuring said first analog signal.

25. The system according to claim 24, wherein said at least one circuit is part of said first device.

26. The system according to claim 24, wherein said at least one circuit is part of said second device.

27. The system according to claim 24, wherein said at least one circuit is part of a third electronic device external to said first and second devices.

28. The system according to claim 21, wherein, during the implementation of said operation, the first device is in a secure mode.

29. The system according to claim 21, wherein said second device is configured to verify said signature by using at least one signature model.

30. The system according to claim 21, wherein said second device is configured to verify said signature by comparing it with said at least one signature model.

31. The system according to claim 21, wherein said second device is configured to verify said signature by extracting data from said signature.

32. The system according to claim 31, wherein said second device comprises a neural network configured to verify said signature.

33. The system according to claim 32, wherein said neural network has been trained based on data representing signature models.

34. The system according to claim 21, wherein, when said signature is transmitted between the first and second devices, said signature is encrypted.

35. The system according to claim 21, wherein said authentication is of verifier/prover type.

36. The system according to claim 21, wherein a signature of at least one second analog signal of said first device is used for the authentication.

37. The system according to claim 21, wherein said first analog signal comprises an excess current rejected by a current smoothing circuit of a circuit for powering said first device.

38. The system according to claim 37, wherein said circuit for powering said first device comprises an analog-to-digital converter configured to measure said excess current, said analog-to-digital converter being configured to store data into a memory.

39. An electronic device configured as the first device in the system according to claim 21.

40. An electronic device configured as the second device in the system according to claim 21.
